(19) United States
(12) Patent Application Publication
(10) Pub. No.: US 2012/0072264 A1
(43) Pub. Date: Mar. 22, 2012

(54) SYSTEMS AND METHODS FOR GENERATING PROSPECT SCORES FOR SALES LEADS, SPENDING CAPACITY SCORES FOR SALES LEADS, AND RETENTION SCORES FOR RENEWAL OF EXISTING CUSTOMERS

(76) Inventor: Len Perna, Haddonfield, NJ (US)

(21) Appl. No.: 13/230,819

(22) Filed: Sep. 12, 2011

Related U.S. Application Data
(60) Provisional application No. 61/381,778, filed on Sep. 10, 2010.

(51) Int. Cl. G06Q 10/00

(52) U.S. Cl. 705/7.32; 705/7.29

(57) ABSTRACT

The present disclosure describes, among other things, a method. The method may include collecting data about individuals. The method may include identifying a pattern of data correlated with a behavior of interest in the data collected for an individual. The method may include defining the individual as a target potential customer in light of the pattern identified in the data collected for the individual.

### RELATED APPLICATION

This application claims priority to U.S. Application No. 61/381,778, filed Sep. 10, 2010 and entitled, “Systems and Methods for Generating Prospect scores for Sales Leads and Retention Scores for Renewal of Existing Customers,” the contents of which are hereby incorporated by reference in their entirety.

### BACKGROUND

Event businesses often need to direct substantial amounts of effort into selling tickets to events and/or retaining current customers. Identifying individuals and/or households likely to purchase tickets and/or account holders at risk of lapsing can make marketing efforts more cost effective.

### SUMMARY

A prospect evaluation and/or scoring platform can receive and aggregate data about prospective customers (also referred to herein as “prospects”). For example, the platform can receive data (e.g., demographic data) from a platform user's customer relationship management (CRM) database, questionnaires answered by the prospect, websites visited by the prospect, and/or historical ticketing information or prior purchase information associated with the platform user, by way of example. Based on this information, the platform can develop and refine a statistical model to predict the amount of money a prospect is likely to spend on the platform user's product (e.g., tickets for events; sponsorship spends; interest in buying certain merchandise products). The amount of money can be translated into a prospect score or rating (e.g., five stars being the best and 1 star being the worst). Also, the platform can develop and refine another statistical model to predict the likelihood a current customer will continue purchasing products, thus presenting the platform user with an improved opportunity to retain the customer. Thus, the platform can generate a retention score. With the prospect and retention scores, the platform user can identify, segment, contact, and market and sell the most promising leads.

By having a reliable predictor of future spend levels of sales prospects and also existing customers, platform users can tailor and apply their marketing, sales and other resources and investments accordingly to optimize their return on investment. Such application improves efficiency and income yields while reducing their marketing and sales costs.

In some aspects, the present disclosure is directed to a method. The method may include collecting data about individuals. The data may include data relating to at least one of: purchase of a ticket to a sporting event, frequency of purchase of tickets to sporting events, purchase of memorabilia related to a sporting organization, frequency of purchase of memorabilia related to the sporting organization, purchase of a ticket to a live entertainment event, frequency of purchase of tickets to live entertainment events, membership in a fan club for the sporting organization, subscription to a sports-related publication, web browser history related to interest in the sporting organization, a historical amount spent on goods related to the sporting organization, self-reported interest in the sporting organization, a response to communication from the sporting organization, household income, household composition, age, gender, area of residence, distance from residence to a location hosting sporting events associated with the sporting organization, length of residency, household income, homeownership status, type of property owned, value of property owned, number of children, age of the children, and level of education.

The method may include identifying a first pattern of data correlated with a behavior of interest in the data collected for an individual. The behavior of interest may include at least one of: purchase of a ticket to a sporting event, purchase of a premium-level ticket to a sporting event, purchase of a package of tickets for the sporting organization, purchase of a ticket subscription for the sporting organization, purchase of a ticket to an event associated with the sporting organization, and combinations thereof. The method may include identifying a second pattern of data correlated with a spending capacity in the data collected for the individual. The method may include defining the individual as a target potential customer in light of the first and second patterns identified in the data collected for the individual.

Collecting data may include collecting a first set of data selected from data relating to: purchase of a ticket to a sporting event, frequency of purchase of tickets to sporting events, purchase of memorabilia related to a sporting organization, frequency of purchase of memorabilia related to the sporting organization, purchase of a ticket to a live entertainment event, frequency of purchase of tickets to live entertainment events, membership in a fan club for the sporting organization, subscription to a sports-related publication, web browser history related to interest in the sporting organization, a historical amount spent on goods related to the sporting organization, self-reported interest in the sporting organization, a response to communication from the sporting organization, household income, and/or household composition.

Collecting a second set of data may include collecting data relating to: age, gender, area of residence, distance from residence to a location hosting sporting events associated with the sporting organization, length of residency, household income, homeownership status, type of property owned, value of property owned, number of children, age of the children, and/or level of education.

The web browser history related to interest in the sporting organization may include a number of viewings of a website for purchasing a ticket for sporting events. The self-reported interest in the sporting organization may include interest reported in a questionnaire, a survey, or both. The location hosting a sporting event associated with the sporting organization may include a sporting arena or a sporting stadium. The purchase of a ticket subscription for the sporting organization may include purchase of tickets for a full season. The purchase of a ticket subscription for the sporting organization may include purchase of tickets for a partial season. The purchase of a ticket to an event associated with the sporting organization may include purchase of a ticket to a live entertainment event hosted in conjunction with the sporting organization. The purchase of a ticket to an event associated with the sporting organization may include purchase of a ticket to an event tailored to existing supporters of the sporting organization. The purchase of a ticket to an event associated with the sporting organization may include purchase of a ticket to meet or travel with members of the sporting organization.

In some aspects, the present disclosure is directed to a method. The method may include collecting data about individuals. The data may include at least data relating to: purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, or household composition.

The method may include identifying a pattern of data correlated with a behavior of interest in the data collected for an individual. The behavior of interest may include at least one of: purchase of a ticket to a sporting event, purchase of a package of tickets for a sporting organization, purchase of a ticket subscription for the sporting organization, or combinations thereof. The method may include defining the individual as a target potential customer in light of the pattern identified in the data collected for the individual.

In some aspects, the present disclosure is directed to a method. The method may include providing a database of values for a plurality of variables. The plurality of variables may include at least one of: purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, and/or household composition. The method may include correlating a variable with a likelihood to purchase a ticket to a sporting event based on the values in the database.

In some aspects, the present disclosure is directed to a method. The method may include providing values for a plurality of variables corresponding to customer characteristics. The method may include identifying from the plurality of variables, a set of variables relating to an interest in sporting activity. The set of variables may include at least one of: purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, and/or household composition. The method may include selecting a value for each variable in the set of variables. The method may include determining a priority rating for the selected values, the priority rating corresponding to a likelihood of purchasing a ticket to a sporting event.

In some aspects, the present disclosure is directed to a method. The method may include providing values for a plurality of variables corresponding to customer characteristics. The method may include identifying from the plurality of variables, a set of variables relating to a capacity for spending. The set of variables may include at least one of: age, gender, area of residence, distance from residence to a location hosting a sporting event associated with a sporting organization, length of residency, household income, homeownership status, type of property owned, value of property owned, number of children, age of the children, and/or level of education. The method may include selecting a value for each variable in the set of variables. The method may include determining a spending capacity rating for the selected values. The spending capacity rating may correspond to an ability to make purchases.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1 is a block diagram that depicts an embodiment of a system for generating prospect scores, spending capacity scores, and retention scores for sales leads;

FIGS. 2A and 2B are block diagrams of exemplary computing devices used in the system of FIG. 1;

FIG. 3 is a flow diagram that depicts an embodiment of a method for generating prospect scores, spending capacity scores, and retention scores for sales leads;

FIGS. 4-16 are exemplary screenshots of interfaces for viewing data about individual prospects;

FIG. 17 is a flow diagram that depicts an embodiment of a method for generating a prospect score for an individual and/or household;

FIG. 18 is a flow diagram that depicts an embodiment of a method for correlating a variable with a likelihood to purchase a ticket;

FIG. 19 is a flow diagram that depicts an embodiment of a method for determining a priority rating, corresponding to a likelihood of purchasing a ticket to a sporting event, associated with a set of values for a set of variables;

FIG. 20 is a flow diagram that depicts an embodiment of a method for determining a spending capacity rating, corresponding to an ability to make purchases, associated with a set of values for a set of variables;

FIG. 21 is a flow diagram that depicts an embodiment of a method for defining an individual as a target potential customer; and

FIG. 22 is a flow diagram that depicts an embodiment of a method for generating a retention score for an individual and/or household.

### DETAILED DESCRIPTION

Event businesses, engaged in events such as music concerts, sporting events, performing arts, movies, fairs, festivals, speakers, conventions, conferences, by way of example, practice similar business behaviors. Event businesses market and sell tickets for admission to individual events, and often they market and sell full or partial season tickets (sometimes called “subscriptions plans” or “mini plans”) to multiple events or a special subset, package, or series of events. Event businesses can market and sell Personal Seat Licenses (“PSLs”), which entitle the holder to purchase one or more seats at some point in the future. Event businesses can market and sell upgraded experiences at events, for example, premium seating (e.g., club seats, suites, hospitality tents) with better views of the event or better amenities, such as better food service or pre-packed merchandise. Event businesses can market and sell advertising and sponsorships to companies that want to reach the same audiences likely to be interested in the event(s). Event businesses can market and sell food and beverages at the events. Event businesses can market and sell merchandise not only at the event(s) but also before, during and after the event(s) on websites associated with the event(s). In this manner, event businesses market and sell a wide variety of products and services in connection with a single “event” or series of “events.”Although examples described herein refer to event tickets, the examples can be applied to any of the products and services offered by the event business.

An event business's success, sustainability, viability and/or profitability can be driven in large measure by the number and type of event tickets that can be sold in a cost-efficient manner, the price/revenue attainable from each level of ticketing, and/or the ability to bundle tickets together in packages/subscription plans and sell them to individuals or businesses in bulk. The ability to close deals in advance of the event(s) for the greatest number of bulk tickets at the highest possible price point brings in revenue, and it also enables the event business to expend fewer resources to market and sell the remaining inventory of tickets in the day(s) leading up to the event(s). Database marketing and telemarketing does not enable event businesses to separate legitimate, qualified sales leads worthy of pursuit or investment from other sales leads that may have a casual interest in the event(s) but are actually not capable or qualified to make a purchase at the price level necessary to get a ticket. Thus, database marketing and telemarketing can be extremely inefficient methods of generating sales, resulting in low yields.

The present disclosure recognizes that a pattern within data regarding an individual may indicate the individual's likelihood of engaging in behavior of interest. Exemplary behaviors of interest may include purchasing a ticket to an event, purchasing a premium-level ticket to an event (e.g., a ticket for a seat in a corporate box at a baseball game), purchasing a package of tickets (e.g., tickets for four separate baseball games; tickets for four separate performances for a theater company), purchasing a ticket subscription for an organization (e.g., a season ticket), and/or purchasing a ticket to an event associated with an organization (e.g., a travel package with members of a football team). A pattern within data regarding an individual may indicate the individual's spending capacity. Patterns within data regarding a household may also indicate the likelihood of the household engaging in a behavior of interest and/or the household's spending capacity.

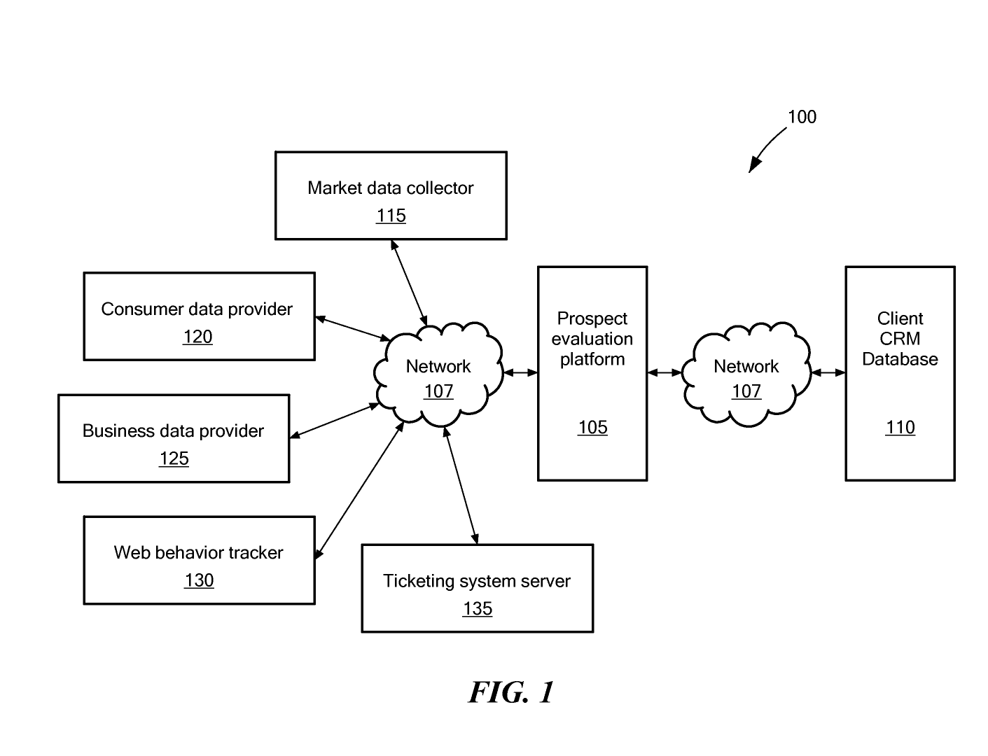

FIG. 1 is a block diagram that depicts an embodiment of a system 100 for generating prospect, spending capacity, and retention scores. The system 100 includes a prospect evaluation platform 105 that communicates over networks 107 with a client (or “user”) customer relationship management (CRM) database 110. The prospect evaluation platform 105 also communicates with various sources of sales-related data sources, such as a market data collector 115, consumer data provider 120, business data provider 125, web behavior tracker 130, and ticketing system server 135. In general overview, the platform 105 obtains information about new prospects from the various sources of data. The platform 105 can communicate with the CRM database 110 for information about the prospects to augment newly received information, or to create records for new prospects. Using the information from all these sources, the platform 105 can generate statistical models. The statistical models may predict the amount of money a prospect will spend on tickets for events and the likelihood an existing customer will continue to make future purchases. The statistical models may predict the likelihood a prospect will engage in a behavior of interest. The statistical models may estimate a spending capacity of a prospect. The platform 105 can apply these models to information about prospects to generate prospect, spending capacity, and/or retention scores for each one, and the scores can be transmitted or made available to sales representative.

The prospect evaluation platform 105 can handle any method of data transfer. Files can be pushed into or pulled from the server platform 105, and custom-developed transfer scripts can be developed to expand the transfer requirements of the platform 105. The prospect evaluation platform 105 can transfer data via FTP or SFTP, by way of example. The platform 105 can receive files to an access-controlled FTP directory, pull files from a client directory, or push files out via FTP. The FTP can be performed with or without SSH if desired. The prospect evaluation platform 105 can transfer data via XMLHTTP. The platform can post files to an access controlled site on the platform side and trigger an action (such as a web page ping) on the client side to notify the client processes that the file is available for download via XMLHTTP. The prospect evaluation platform 105 can receive files in the same manner. The prospect evaluation platform 105 can transfer data via web services. The platform 105 can access and call a web service on the client side to perform all data transfer, have a web service that can be exposed to the client, or both. The prospect evaluation platform 105 can transfer data via e-mail. The platform can transmit data to any email addresses and accept data via e-mail.

Data originating from or being imported into the prospect evaluation platform can be in any defined format. Some exemplary formats can be accessible via a text editor, such as XML, plain text, CSV, and custom-delimited text files.

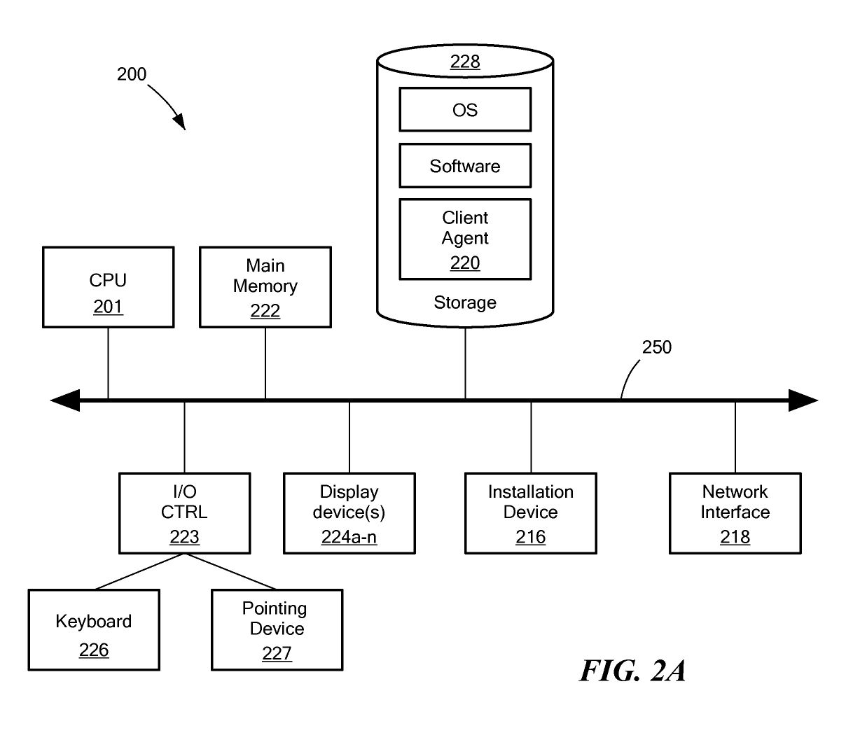

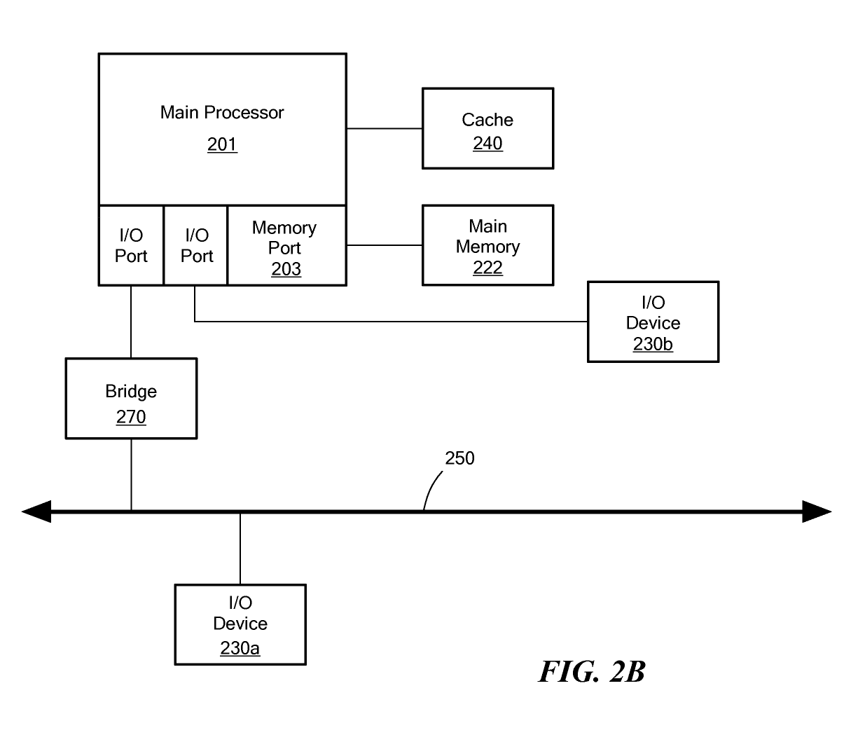

FIGS. 2A and 2B depict block diagrams of a computing device 100 useful for practicing an embodiment of the platform 105. As shown in FIGS. 2A and 2B, each computing device 200 includes a central processing unit 201, and a main memory unit 222. As shown in FIG. 2A, a computing device 200 may include a visual display device 224, a keyboard 226 and/or a pointing device 227, such as a mouse. Each computing device 200 may also include additional optional elements, such as one or more input/output devices 230a-230b (generally referred to using reference numeral 230), and a cache memory 240 in communication with the central processing unit 201.

The central processing unit 201 is any logic circuitry that responds to and processes instructions fetched from the main memory unit 222. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 200 may be based on any of these processors, or any other processor capable of operating as described herein.

Main memory unit 222 may be one or more memory chips capable of storing data and allowing any storage location to be directly accessed by the microprocessor 201, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 222 may be based on any of the above described memory chips, or any other available memory chips capable of operating as described herein. In the embodiment shown in FIG. 2A, the processor 201 communicates with main memory 222 via a system bus 250 (described in more detail below). FIG. 2A depicts an embodiment of a computing device 200 in which the processor communicates directly with main memory 222 via a memory port 203. For example, in FIG. 2B the main memory 222 may be DRDRAM.

FIG. 2B depicts an embodiment in which the main processor 201 communicates directly with cache memory 240 via a secondary bus, sometimes referred to as a backside bus. In other embodiments, the main processor 201 communicates with cache memory 240 using the system bus 250. Cache memory 240 typically has a faster response time than main memory 222 and is typically provided by SRAM, BSRAM, or EDRAM. In the embodiment shown in FIG. 2A, the processor 201 communicates with various I/O devices 230 via a local system bus 250. Various busses may be used to connect the central processing unit 201 to any of the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 224, the processor 201 may use an Advanced Graphics Port (AGP) to communicate with the display 224. FIG. 2B depicts an embodiment of a computer 200 in which the main processor 201 communicates directly with I/O device 230 via HyperTransport, Rapid I/O, or InfiniBand. FIG. 2B also depicts an embodiment in which local busses and direct communication are mixed: the processor 201 communicates with I/O device 230 using a local interconnect bus while communicating with I/O device 230 directly.

The computing device 200 may support any suitable installation device 216, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any client agent 220, or portion thereof. The computing device 200 may further comprise a storage device 228, such as one or more hard disk drives or redundant arrays of independent disks, for storing an operating system and other related software, and for storing application software programs such as any program related to the client agent 220. Optionally, any of the installation devices 216 could also be used as the storage device 228. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 200 may include a network interface 218 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 218 may comprise a built-in network adapter, network interface card, PCMCIA network card, card bus network adapter, wireless network adapter, USB network adapter, modem or any other device suitable for interfacing the computing device 200 to any type of network capable of communication and performing the operations described herein.

A wide variety of I/O devices 230a-230n may be present in the computing device 200. Input devices include keyboards, mice, trackpads, trackballs, microphones, and drawing tablets. Output devices include video displays, speakers, inkjet printers, laser printers, and dye-sublimation printers. The I/O devices 230 may be controlled by an I/O controller 223 as shown in FIG. 2A. The I/O controller may control one or more I/O devices such as a keyboard 226 and a pointing device 227, e.g., a mouse or optical pen. Furthermore, an I/O device may also provide storage 228 and/or an installation medium 216 for the computing device 200. In still other embodiments, the computing device 200 may provide USB connections to receive handheld USB storage devices such as the USB Flash Drive line of devices manufactured by Twintech Industry, Inc. of Los Alamitos, Calif.

In some embodiments, the computing device 200 may comprise or be connected to multiple display devices 224a-224n, which each may be of the same or different type and/or form. As such, any of the I/O devices 230a-230n and/or the I/O controller 223 may comprise any type and/or form of suitable hardware, software, or combination of hardware and software to support, enable or provide for the connection and use of multiple display devices 224a-224n by the computing device 200. For example, the computing device 200 may include any type and/or form of video adapter, video card, driver, and/or library to interface, communicate, connect or otherwise use the display devices 224a-224n. In one embodiment, a video adapter may comprise multiple connectors to interface to multiple display devices 224a-224n. In other embodiments, the computing device 200 may include multiple video adapters, with each video adapter connected to one or more of the display devices 224a-224n. In some embodiments, any portion of the operating system of the computing device 200 may be configured for using multiple displays 224a-224n. In other embodiments, one or more of the display devices 224a-224n may be provided by one or more other computing devices, such as computing devices 200a and 200b connected to the computing device 200, for example, via a network. These embodiments may include any type of software designed and constructed to use another computer's display device as a second display device 224a for the computing device 200. One ordinarily skilled in the art will recognize and appreciate the various ways and embodiments that a computing device 200 may be configured to have multiple display devices 224a-224n.

In further embodiments, an I/O device 230 may be a bridge 270 between the system bus 250 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 200 of the sort depicted in FIGS. 2A and 2B typically operate under the control of operating systems, which control scheduling of tasks and access to system resources. The computing device 200 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 200 may have different processors, operating systems, and input devices consistent with the device. Moreover, the computing device 200 can be any workstation, desktop computer, server, any other computer, or other form of computing or telecommunications device that is capable of communication and that has sufficient processor power and memory capacity to perform the operations described herein.

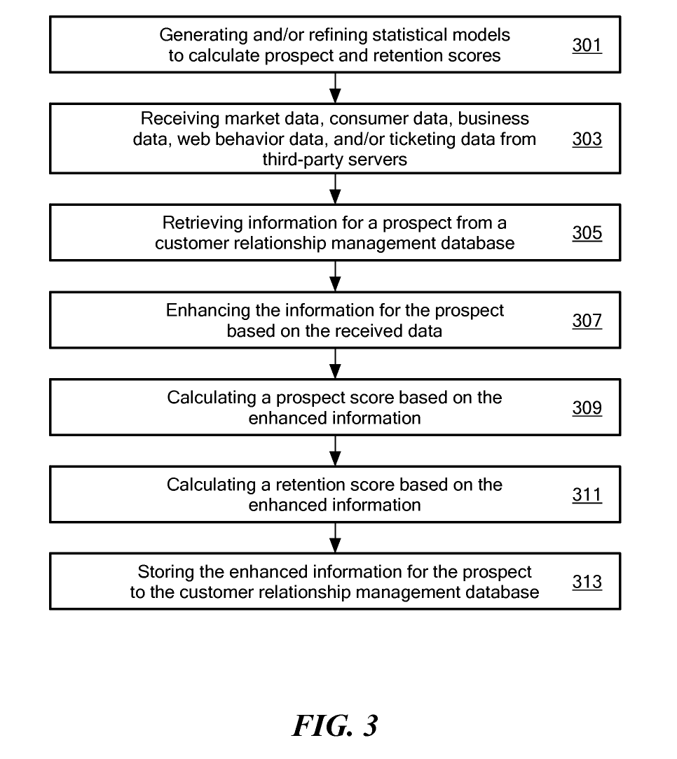

FIG. 3 is a flow diagram that depicts an embodiment of a method for generating prospect and retention scores. The method includes generating and/or refining statistical models to calculate prospect scores for sales leads and retention scores for existing customers (step 301) to predict potential spend or renewal action. The statistical model can be based on a client of the prospect evaluation platform 105, and different models can be used for different clients. The platform 105 accesses information about a client's customers from the CRM database 110. The platform 105 also uses information about the client's customers obtained from any of the data sources described in reference to FIG. 1. In some embodiments, the platform 105 obtains information from the CRM database 110 and/or other data sources at predetermined period throughout the day or as new information becomes available. In this manner, the platform 105 can develop statistical models based on the most current set of data and update models and prospect, spending capacity, and/or retention scores based on the same.

Based on the data, the platform 105 develops a statistical model to determine identifying characteristics and the extent of their impact with respect to, for example, season ticket holders, or other categories of ticket purchasers. In some embodiments, the platform 105 initially considers an unlimited number of variables based on inputs obtained while collecting data about client customers. An initial model can account for all variables, and the platform 105 can evaluate the strength of the model via the coefficient of determination or any other statistical measure associated with the prediction of future outcomes on the basis of other related information. In some embodiments, the platform 105 creates a statistical model for a client based on a template that accounts for variables with the highest impact for comparable clients. The platform 105 can then proceed to refine the template on a rolling basis as new data enters the platform.

The platform 105 can eliminate variables from the model and re-evaluate the refined model's strength. In this manner, the platform 105 can iteratively eliminate and/or replace variables until the platform 105 has maximized the model's accuracy. The final model can include coefficients and exponents associated with the highest impact variables. The sum of the coefficients multiples by the values of the highest impact variables for a prospect can yield the predicted amount a prospect will spend on tickets for the client's sporting events. In some embodiments, the resultant model can be represented by a linear or non-linear formula. The amount can be translated into a rating (i.e. a score) for the prospect.

The platform 105 can generate and/or refine a statistical model to calculate retention scores in a comparable manner. Like the model for prospect scores, the model for retention scores can be based on information about customers in the CRM database 110 or information obtained from any of the data sources described in reference to FIG. 1. The data can include information like a prospect's historical attendance at events (i.e., the frequency with which the prospect's tickets were scanned over the course of a season or series of events); the number of contacts a prospect has had with event representatives, and/or the types of points of contact between the prospect and the event business organization. As with the model for prospect scores, the platform 105 can add or eliminate variables from the model and re-evaluate the refined model's strength. The final model can include coefficients associated with the highest impact variables. The final model can manipulate the coefficients and variables to yield an assessment of the prospect's likelihood to continue a customer relationship with the event(s), such as a probability. In some embodiments, the resultant model can be represented by a linear or non-linear formula. After generating the statistical models, the prospect evaluation platform 105 can collect data about potential prospects from a large number and variety of sources (step 303). This data can be collected on an on-going basis, either in batch form or continuously in real time. For example, visitors to the websites of the prospect evaluation platform's clients can fill out personal identification forms that are tracked using on-line javascript tags (e.g., web behavior tracker 130) inserted on the websites' pages. Thus, the visitors and their pertinent web behaviors can be tracked in the prospect evaluation platform.

Clients can also employ a survey or questionnaire to collect prospects to be fed into the prospect evaluation system. These surveys can be sent outbound to a list of prospects, linked on the client website, or even gathered face-to-face using, for example, mobile computing devices (with or without network connectivity). In some embodiments, the mobile computing devices can be equipped with driver's license scanners to facilitate easy prospect gathering and can be batch synched or wirelessly connected to upload prospects to the prospect evaluation service in real-time.

Further, sales managers and database managers can feed list buys to the prospect evaluation platform 105. Prospects on purchased lists can be ranked, graded, de-duped, enhanced, and/or automatically matched and loaded into the client CRM database 110. The prospect evaluation platform 105 can access prospects from these lists in the CRM, monitoring the prospects and enabling more targeted list buying in the future.

Additionally, prospects can be gathered through delta ticket purchase activity fed by the ticketing company directly to the prospect evaluation platform 105. For example, a ticketing company can inform the prospect evaluation platform 105 that a customer has purchased 10 tickets to one event and 10 single seats to 5 more events, for a total of 6 transactions. In some embodiments, the ticketing company can provide delta ticket purchase activity according to the fields in the following table:

| | |
|---|---|
| TM_ACCOUNT | Team's ticketing company Account ID |
| Account ID | Ticket Buyer's Account Number |
| firstname | |
| middlename | |
| lastname | |
| companyname | |
| Addr1 | |
| Addr2 | |
| City | |
| State | |
| zip | |
| email | |
| phone_day | |
| phone_eve | |
| Event_Name | The name of the event for which the |
| | transaction was posted. |
| team | If the event was a game, the opponent. |
| Event_Date | The actual date of the event. |
| Order_num | A unique identifier for the event. |
| purchase_price | Price of the item purchased, per unit |
| block_purchase_price | Price of transaction (units * unit price) |
| upd_Datetime | Date and time of transaction |
| upd_user | Unique identifier for the user who has sold |
| | the item, if applicable. Preferably and email |
| | address, but if not a lookup must be supplied |
| | by the team or the ticketing company. |

These delta files can be provided to the prospect evaluation platform 105 on behalf of the client nightly, or on a more frequent basis, and any new prospects can likewise be ranked, graded, de-duped, enhanced, and/or automatically matched and loaded into the client CRM.

The prospects can be de-duped and sent to a third-party data processing and record enhancement service. The data processing service can identify the prospects from its massive marketing database, de-dupe the prospects, and return to the prospect evaluation platform 105 an ID code for the prospect. This ID code can be used as a worldwide identification code for the client, identifying prospects uniquely across the prospect evaluation platform and client platforms.

The prospect evaluation platform 105 can communicate with a client's CRM database 110 for any data already obtained about the prospects (step 305). In some embodiments, the prospect evaluation platform 105 can transmit to the CRM database 110 a request for information in the following fields:

| | |
|---|---|
| CRM_ACCOUNT | Team's CRM Account (for hosted CRM |
| | databases) |
| AbilitecID | Prospect's ID code (Individual) |
| firstname | |
| middlename | |
| lastname | |
| Addr1 | |
| Addr2 | |
| City | |
| State | |
| zip | |
| Email | |
| phone_day | |
| phone_eve | |
| TicketingAccountNum | This is the ticketing account number for this |
| | contact, if we have it yet. |

Any data exchange with the CRM database 110 need only the ID code to indicate a contact, although the prospect evaluation platform 105 can send and receive other keys as necessary for each prospect. In this manner, the prospect evaluation platform 105 can receive back from the client's CRM database 110 any revisions to the data but maintain the continuity of the record. These prospects may or may not exist in the client CRM database 110. If the CRM cannot match a prospect with a record in the CRM, the CRM creates a new record.

If the client has automatic logic for assigning a sales representative to a new prospect, the CRM database 110 can make the assignment and augment the prospect's record accordingly. After this assignment is complete, the CRM database 110 can transmit to the prospect evaluation platform 105 the contents detailed in the following table:

| | |
|---|---|
| CRM_ACCOUNT | Team's CRM Account (for hosted CRM systems) |
| AbilitecID | Prospect's ID code (Individual) |
| Account ID | Prospect's CRM Account Number/primary key |
| SalesPersonID | The CRM's unique ID for the sales rep |
| SalesPersonEmail | The email address of the sales rep |
| firstname | |
| Middlename | |
| lastname | |
| Addr1 | |
| Addr2 | |
| City | |
| State | |
| zip | |
| Email | |
| phone_day | |
| phone_eve | |

The prospect evaluation platform 105 can append to this data a large array of enhancement data (step 307). The prospect evaluation platform 105 can compile a file based on such data to transfer back to the CRM, such as that described in the exemplary table below:

| Field | Length (characters) |
|---|---|
| ProspectID | 12 |
| FirstName | 50 |
| LastName | 50 |
| Email | 100 |
| HomePhone | 20 |
| MobilePhone | 20 |
| Address1 | 100 |
| Address2 | 100 |
| City | 100 |
| State | 3 |
| PostalCode | 10 |
| Country | 50 |
| AbilitecID | 20 |
| Investing - Active | 1 |
| Business Owner | 1 |
| Occupation - Detail - Input | 4 |
| Individual | |
| Vehicle - New Used Indicator - | 1 |
| 1st Vehicle | |
| Vehicle - New Used Indicator - | 1 |
| 2nd Vehicle | |
| Discretionary Income Index | 4 |
| Sports and Leisure - SC | 1 |
| Spectator Sports - Auto/ | 1 |
| Motorcycle Racing | |
| Spectator Sports - Football | 1 |
| Spectator Sports - Baseball | 1 |
| Spectator Sports - Basketball | 1 |
| Spectator Sports - Hockey | 1 |
| Spectator Sports - Soccer | 1 |
| Spectator Sports - Tennis | 1 |
| Collectibles - Sports | 1 |
| Memorabilia | |
| NASCAR | 1 |
| Vehicle - | 3 |
| Truck/Motorcycle/RV Owner | |
| Mail Order Buyer Categories | 31 |
| Mail Order Donor | 1 |
| NetWorth | 1 |
| Home Assessed Value - | 1 |
| Ranges | |
| Home Property Type Detail | 1 |
| Home Square Footage - | 7 |
| Actual | |
| Home Year Built - Actual | 4 |
| Adult Age Ranges Present in | 21 |
| Household | |
| Children's Age Ranges | 15 |
| Present in Household | |
| Occupation - 1st Individual | 1 |
| Occupation - 2nd Individual | 1 |
| Home Owner/Renter | 1 |
| Length of Residence | 2 |
| Dwelling Type | 1 |
| Marital Status in the | 1 |
| Household | |
| Name/Gender - 1st | 12 |
| Individual | |
| Name/Gender - 2nd | 12 |
| Individual | |
| Base Record Verification | 5 |
| Date | |
| Mail Order Buyer | 1 |
| Age in Two-Year Increments - | 2 |
| 1st Individual | |
| Age in Two-Year Increments - | 2 |
| 2nd Individual | |
| Working Woman | 1 |
| Mail Order Responder | 1 |
| Credit Card Indicator | 6 |
| Presence of Children | 1 |
| Age in Two-Year Increments - | 2 |
| Input Individual | |
| Number of Adults | 1 |
| Occupation - Input Individual | 1 |
| InfoBase Positive Match | 1 |
| Indicator | |
| Number of Sources | 2 |
| Income - Estimated | 1 |
| Household | |
| Home Market Value | 1 |
| Vehicle - New Car Buyer | 1 |
| Vehicle - Known Owned | 1 |
| Number | |
| Vehicle - Dominant Lifestyle | 1 |
| Indicator | |
| Online Purchasing Indicator | 1 |
| Apartment Number | 8 |
| Gender - Input Individual | 1 |
| Overall Match Indicator | 1 |
| Credit Card - Frequency of | 7 |
| Purchase | |
| Retail Activity Date of Last | 8 |
| Retail Purchases - Categories | 21 |
| Retail Purchases - Most | 2 |
| Frequent Category | |
| Personicx Cluster Code | 3 |
| Education - 1st Individual | 1 |
| Education - 2nd Individual | 1 |
| Education - Input Individual | 1 |
| Suppression - Mail - DMA | 1 |

Based on the most recent data about a prospect, the prospect evaluation platform 105 can apply the statistical models for prospect and retention to generate scores for an individual or business (steps 309 and 311). In many embodiments, the statistical model for prospect scores predicts the amount of money the prospect is likely to spend on, in the example described in these pages, tickets to an event or a series of events. The platform 105 can assign a rating to the prospect based on the prospect score.

In some embodiments, the platform 105 assigns ratings by comparing the amounts prospects are likely to spend. The platform 105 can assign 5-star ratings to prospects whose likely spend amounts fall within the top 20% of the entire group of prospects, 4-star ratings to prospects whose likely spend amounts fall within the next 20%, and so on. The platform 105 can select any percentages to correspond to the tiers. For example, the platform 105 can associate 5-star ratings with spend amounts in the top 10%, 4-star ratings in the next 20%, and 3-star ratings in the next 30%.

In some embodiments, the platform 105 can segment the prospects demographically before assigning ratings. For example, the platform 105 can segment prospects according to athletic teams, leagues, or geographical region. The platform 105 can compare the prospect scores of prospects within these segments and assign ratings based on the comparisons. The platform 105 can segment the prospects according to any metric as would be understood by one of ordinary skill in the art.

In some embodiments, the platform 105 can assignment ratings based on the absolute values of the amounts prospects are likely to spend. For example, if a prospect score exceeds the price of season tickets for mid- or upper-range seats, the platform 105 can assign the prospect a 5-star rating. If the prospect score falls within the range of season ticket prices for low- and mid-range seats, the platform 105 can assign the prospect a 4-star rating. If the prospect score indicates the prospect may have purchased game packages, the platform 105 can assign the prospect a 3-star rating. These assignments are merely exemplary, and assignments can be altered as preferred by one of ordinary skill in the art.

In various embodiments, the statistical model for prospect scores can assess the similarities between a prospect and current customers. The prospect score can be a percentage indicating the correlation between characteristics of the prospect and the current customers. The platform 105 can assign a rating according to the percentage (e.g., 80%+ correlation results in a 5-star rating, 60-80% correlation results in a 4-star rating, etc.). The platform 105 can segment the prospects and current customers before calculating prospect scores. For example, the platform 105 can compute the correlations between a 25-year-old male prospect with current 20-35-year-old male customers, a 40-year-old male prospect from the Northwest with current 35-50-year-old male customers in the same geographical area, and so on.

Additionally, the statistical model for retention scores calculates the likelihood that the prospect will continue patronizing the business. In many embodiments, the retention score can be a percentage, with 100% indicating high customer loyalty and 0% indicating low customer loyalty. In some embodiments, these scores may be converted to ratings. For example, a high score may indicate high customer loyalty, indicating that the event business is likely to be able to secure future sales from the customer. An average score may indicate some customer loyalty, and it may signal to the event business that additional attention and effort likely needed to secure future sales from the customer.

After the prospect and retention scores are calculated, the prospect evaluation platform 105 can store the enhanced information for the prospect to the customer relationship management database 110 (step 313). In some implementations, the enhanced information can be used for generating and/or refining statistical models to calculate prospect and retention scores, as described in reference to step 301 of FIG. 3.

Although the steps described herein have been applied to a particular example (tickets) and in a particular sequence, the steps may be applied to other event business products and also re-ordered in a different sequence as desired. For example, the platform 105 may recalculate scores for all prospects whenever the statistical models for prospect and retention scores are refined, not simply when new data for prospects becomes available. In another example, the platform 105 may recalculate the prospect scores as new data about prospects becomes available, but calculate the retention scores every few months. There are many different combinations and sequences made possible by the platform for almost any product sold by an event business.

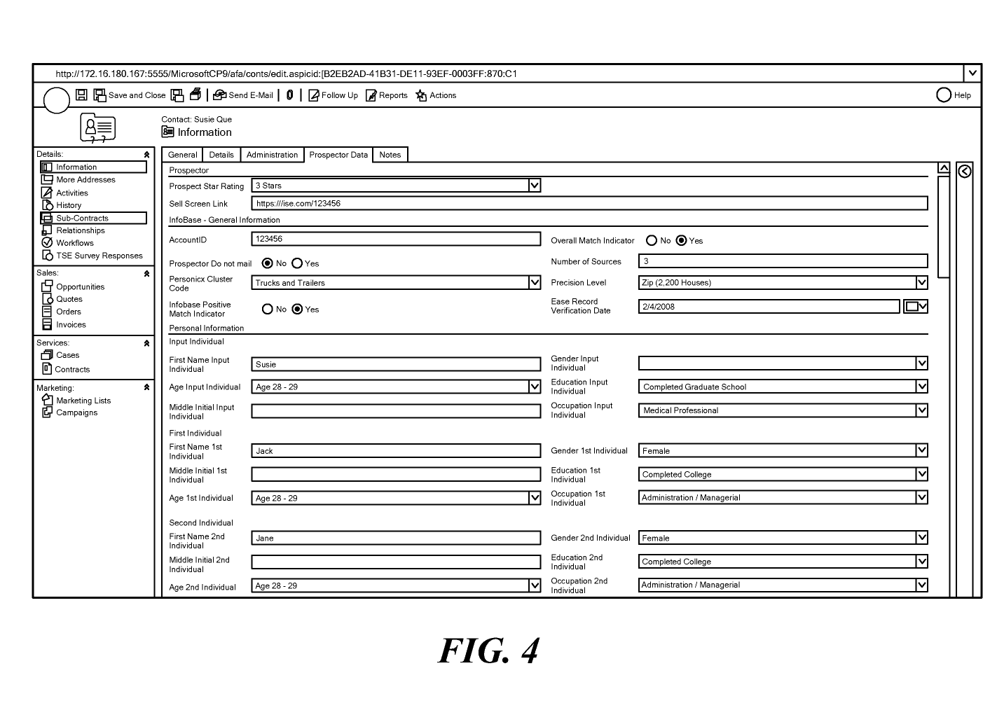

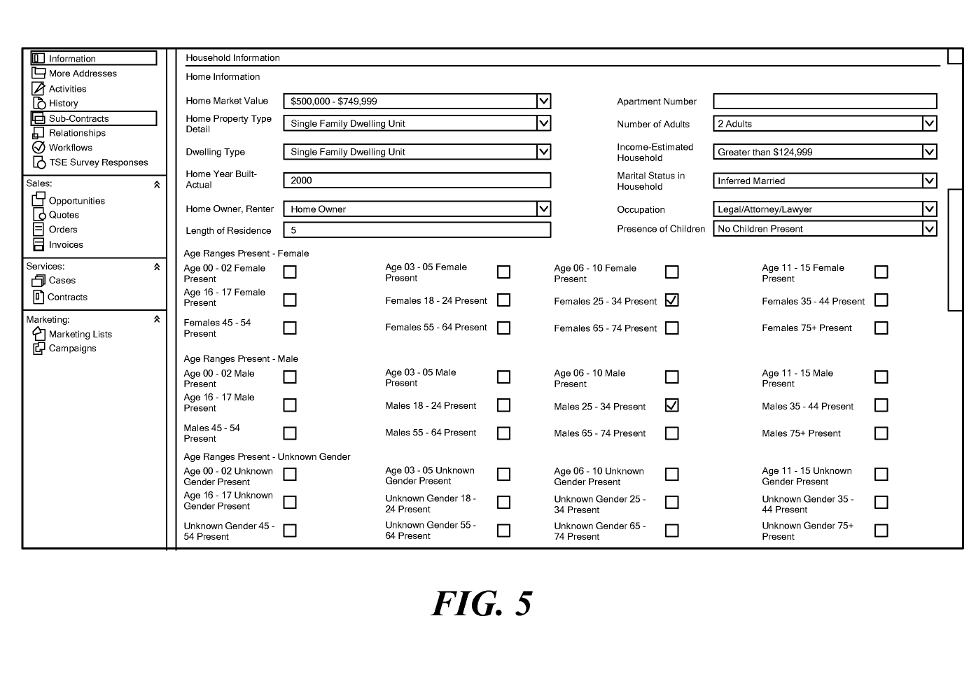

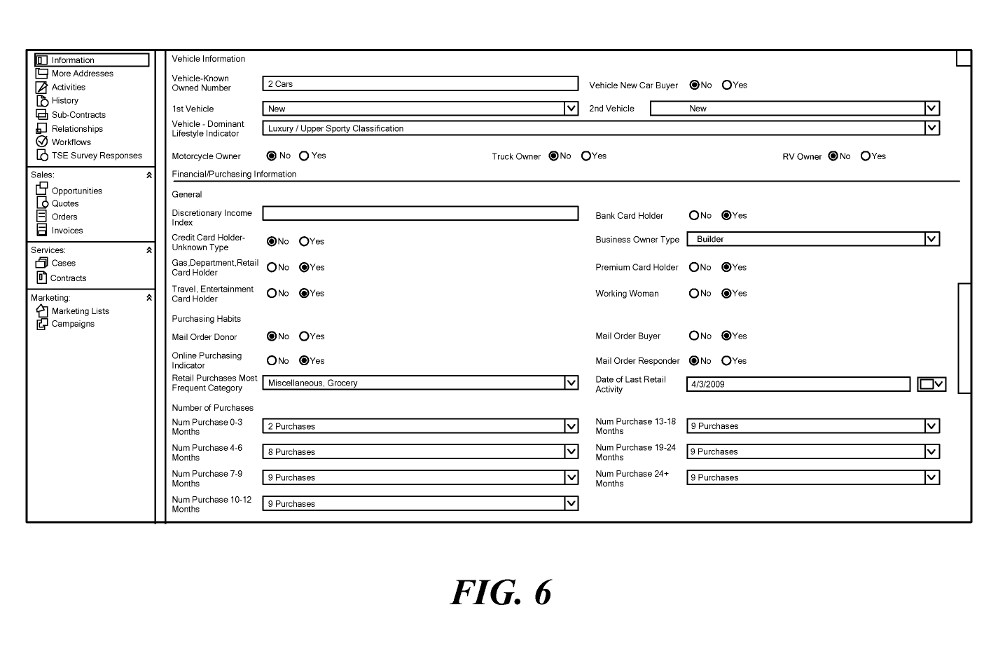

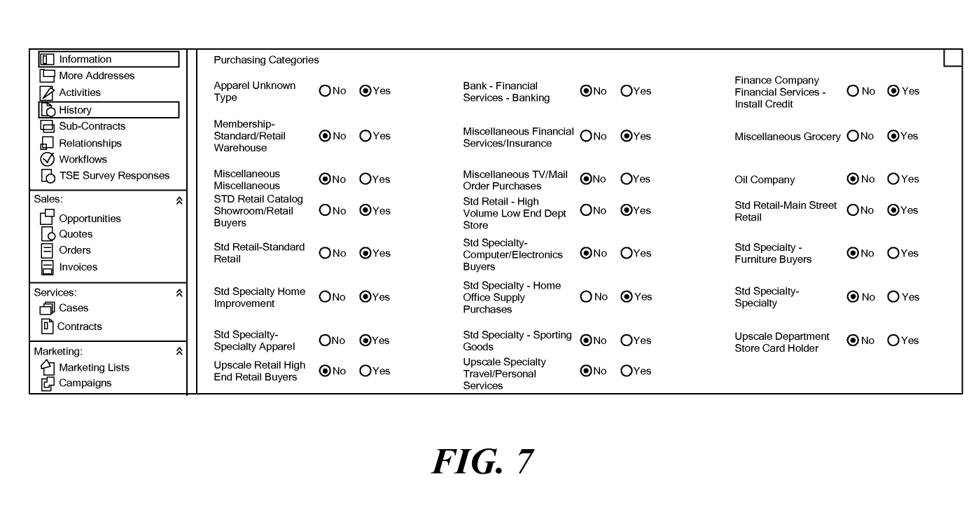

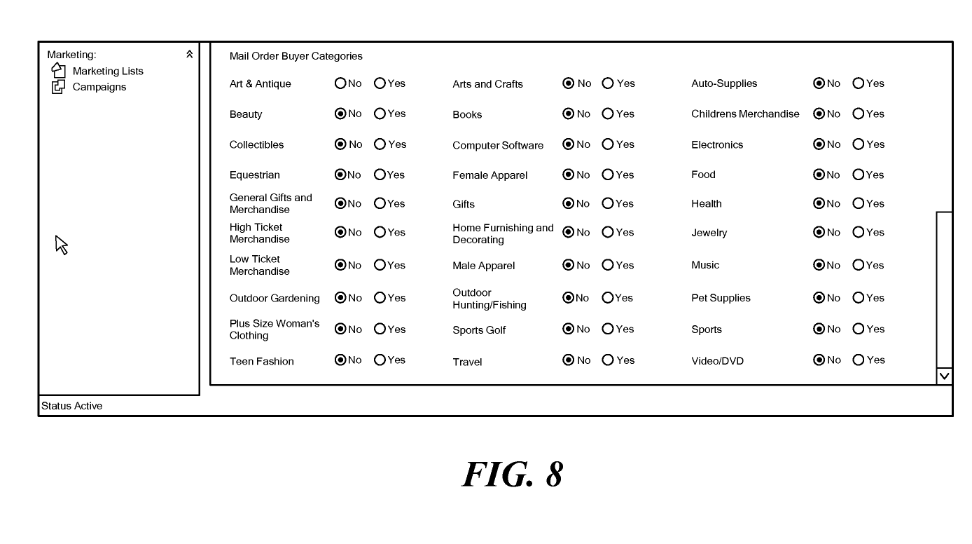

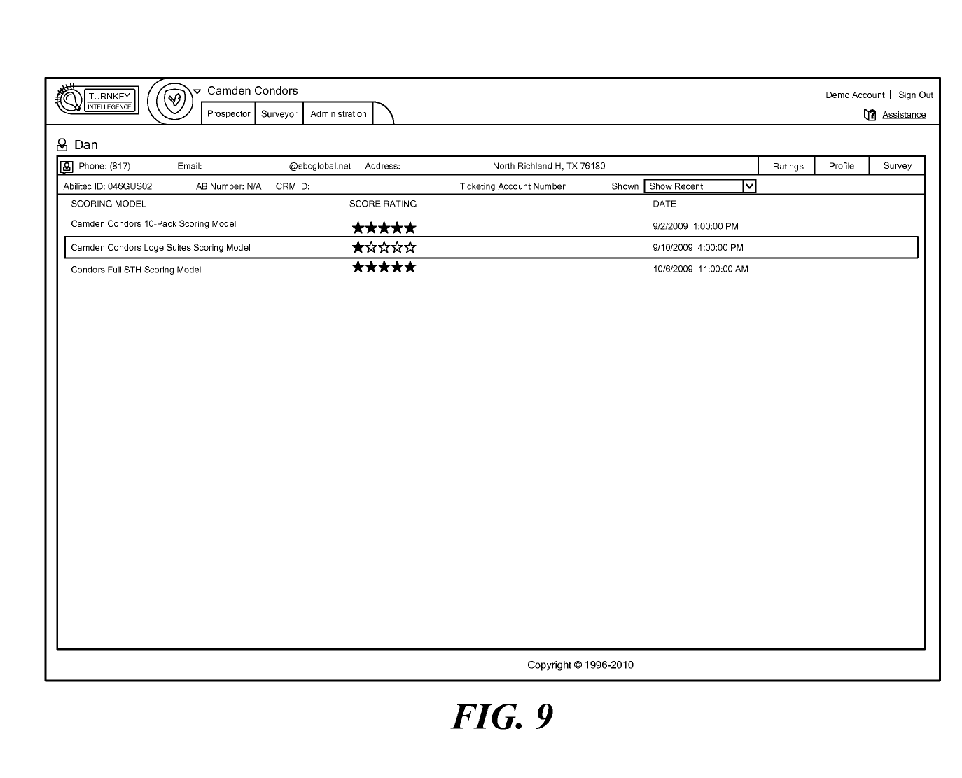

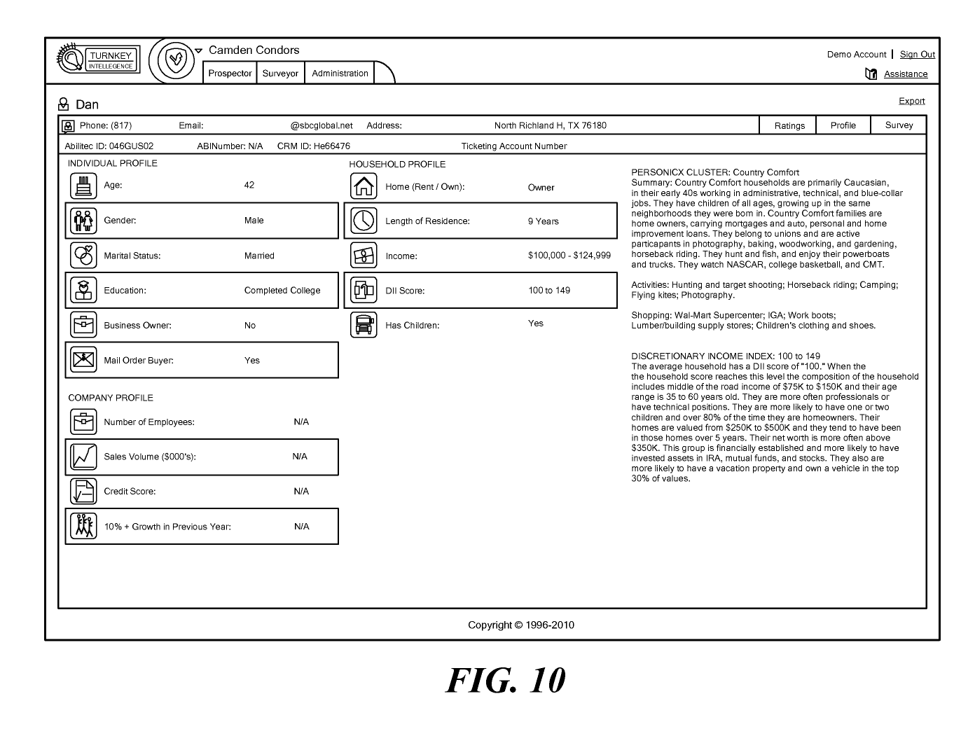

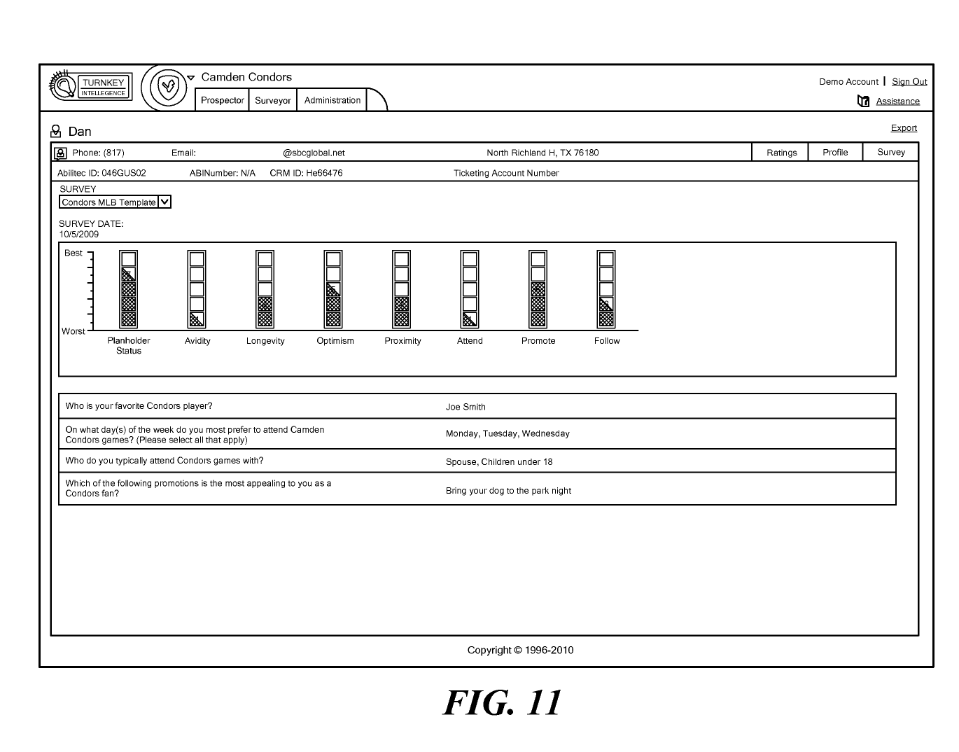

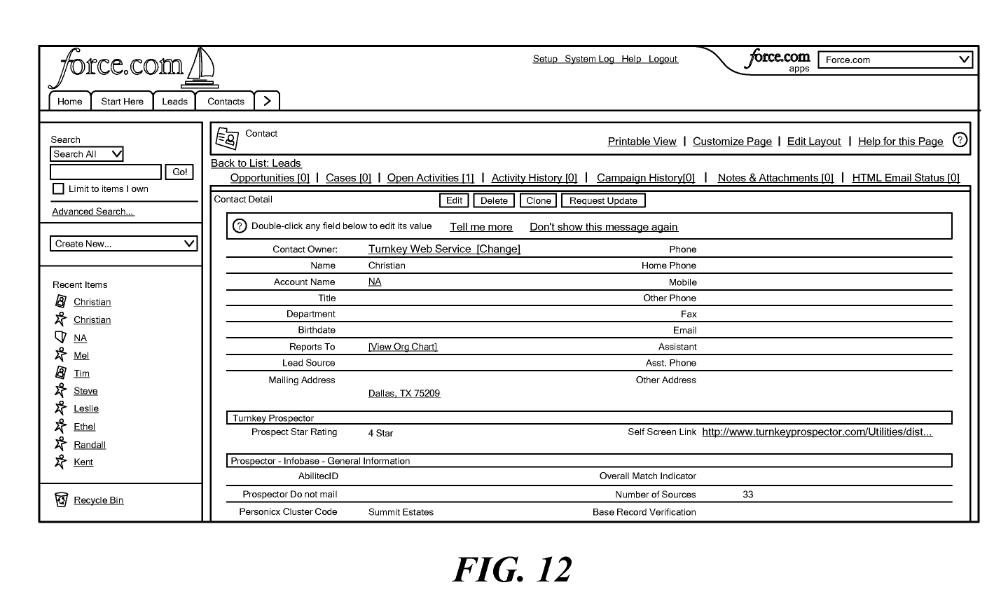

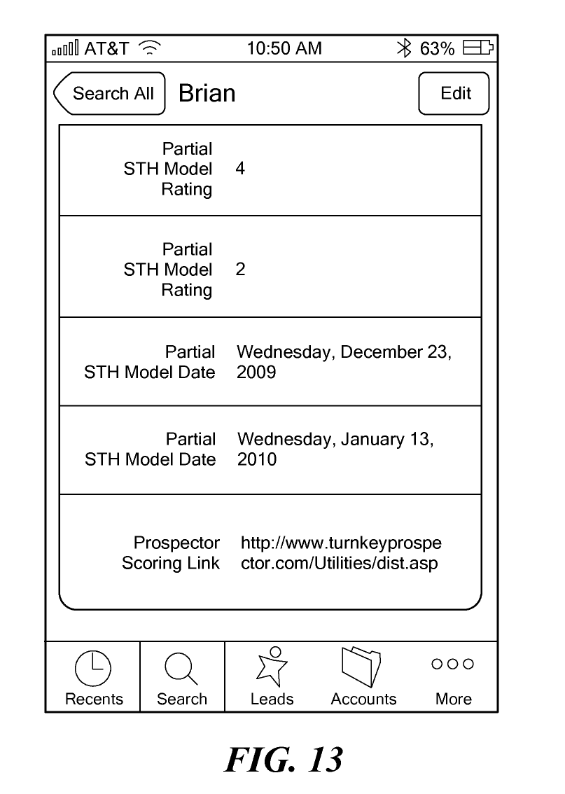

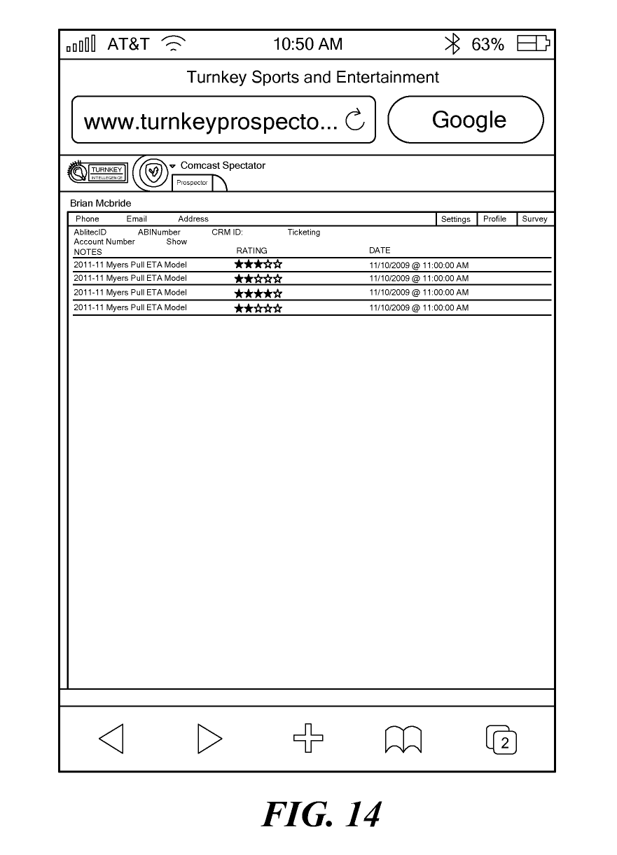

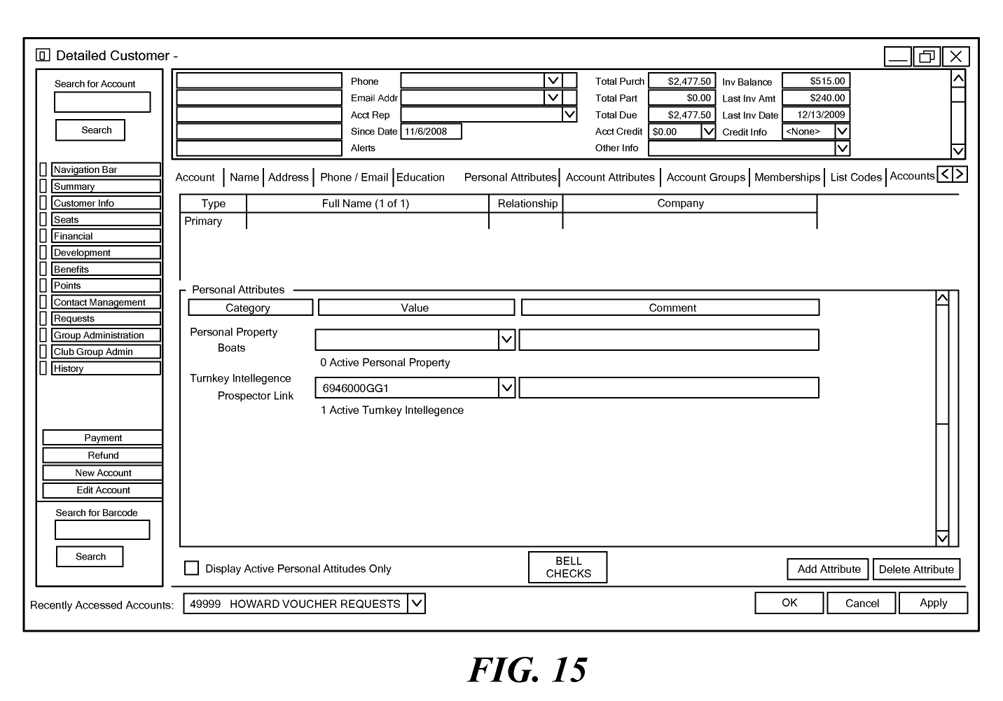

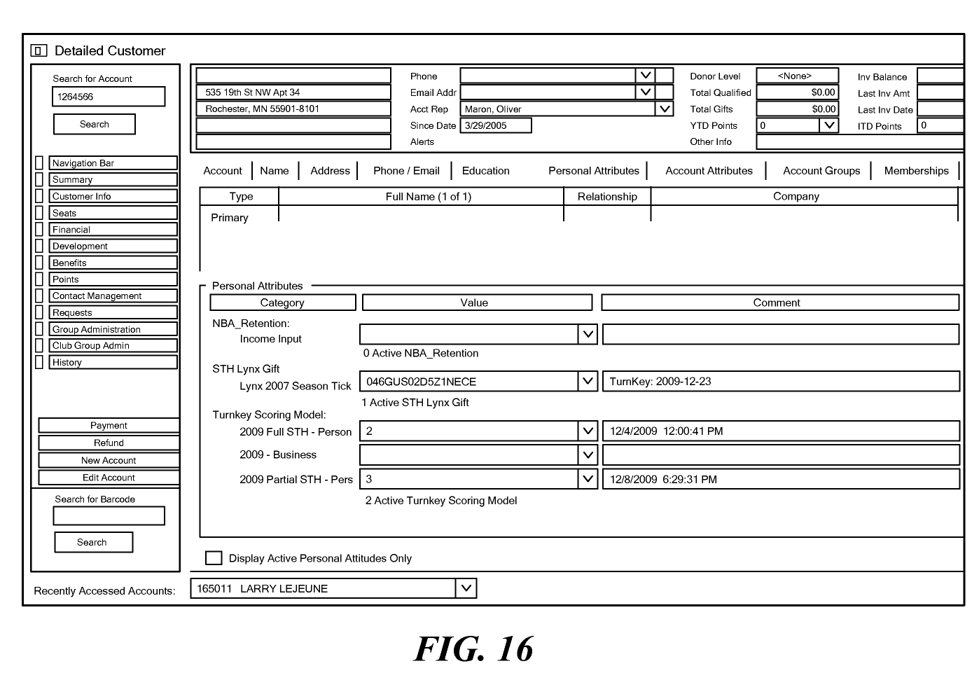

FIGS. 4-16 are exemplary screenshots of an interface for viewing data about individual prospects.

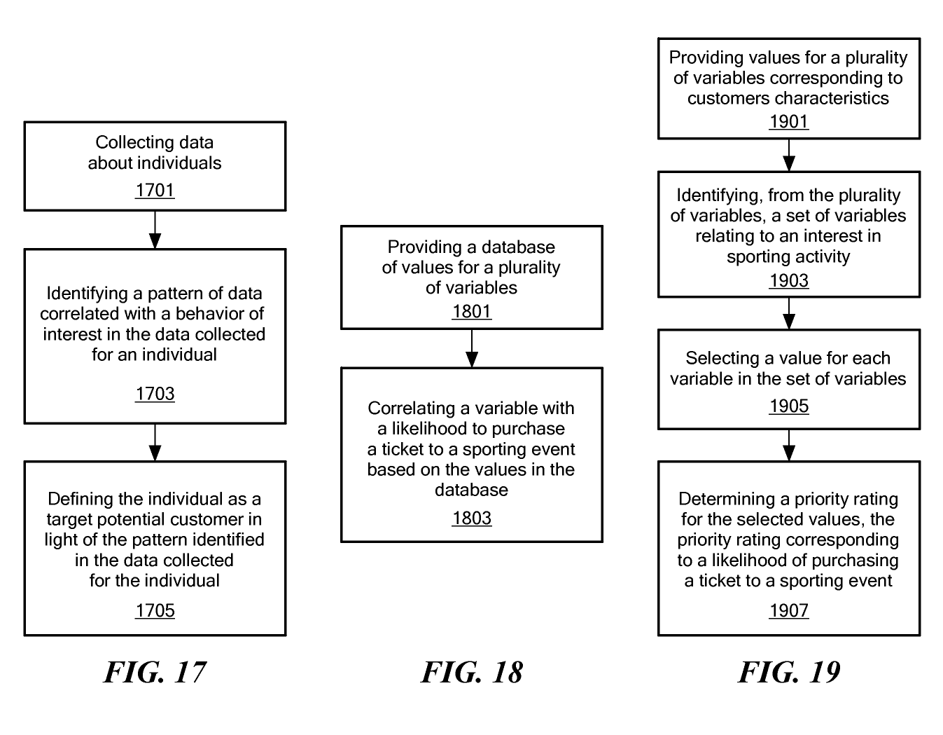

Referring now to FIG. 17, a flow diagram that depicts an embodiment of a method for generating a prospect score for an individual and/or household is shown and described. The method may include collecting data about individuals (step 1701). The data may include at least data relating to purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, or household composition. Any other data about an individual and/or household may be collected, including any of the data described herein.

The processor may determine a correlation between a pattern of data in the data collected for the individuals and a behavior of interest. Exemplary behaviors of interest may include purchasing a ticket to an event, purchasing a premium-level ticket to an event, purchasing a package of tickets, purchasing a ticket subscription for an organization, and/or purchasing a ticket to an event associated with an organization. Exemplary behaviors of interest may include purchasing a ticket to a football game, purchasing a ticket in a loge box for a baseball game, and/or purchasing a package of tickets to four basketball games. An exemplary behavior of interest may include purchasing a season ticket associated with a football team. An exemplary behavior of interest may include purchasing a travel package to see a sports team's games in multiple cities (e.g., tickets to the games, hotel rooms, transportation). An exemplary behavior of interest may include purchasing a ticket to participate in a sports team's “Fantasy Camp.” Other behaviors of interest relating to an organization may be used, in any combination thereof.

A correlation between a pattern of data in the data collected for the individuals and a behavior of interest may be determined in any manner. In some implementations, a processor in a computing device may perform a statistical analysis on the collected data from the users to determine that a pattern of data is correlated with a behavior of interest. In some implementations, the processor may perform linear and/or non-linear analysis on the collected data to determine the correlation. In some implementations, the processor may perform regression to determine the correlation. In some implementations, the processor may determine that the pattern of data is correlated with a behavior of interest when a threshold percentage of individuals whose data matches the pattern have engaged in the behavior of interest.

In some implementations, if 60% of individuals whose data matches a first pattern purchase season tickets for a football team, the processor may determine that the first pattern is correlated with the behavior of purchasing a season ticket. If 80% of individuals whose data matches a second pattern purchase season tickets for a football team, the processor may determine that the second pattern is correlated with the behavior of purchasing a season ticket. In some implementations, if 50% of individuals whose data matches a third pattern purchase packages with tickets to four baseball games, the processor may determine that the third pattern is correlated with the behavior of purchasing multi-game packages of tickets. In some implementations, if 70% of individuals whose data matches a fourth pattern purchase packages with tickets to four baseball games, the processor may determine that the fourth pattern is correlated with the behavior of purchasing multi-game packages of tickets. Likewise, the processor may determine a correlation between any pattern of data collected for the individuals and any behavior of interest.

In some implementations, the pattern of data may be associated with the percentage of individuals whose data matches the pattern that engage in the behavior of interest. In some implementations, the pattern of data may be associated with a prospect score (e.g., 88 out of 100, 63 out of 100), a prospect rating (e.g., 5 stars, 4 stars), or any other metric for conveying the desirability of the individual as a potential customer.

The method may include identifying a pattern of data correlated with a behavior of interest in the data collected for an individual (step 1703). In some implementations, the pattern of data may be modeled as a tree. The tree may account for possible values of the data. As the data collected for an individual is evaluated against the tree, the values may determine which nodes in the tree are to be traversed. In some implementations, evaluating the data against the tree may demonstrate that the individual's data matches the pattern represented by the tree.

The method may include defining the individual as a target potential customer in light of the pattern identified in the data collected for the individual (step 1705). The individual may be identified as a target potential customer when his or her data matches the pattern. The individual may be classified according to the prospect score, prospect rating, or other metric associated with the pattern. For example, if the data collected for an individual matches a pattern of data associated with a prospect rating of 5 stars, the individual may be deemed a 5 star potential customer.

Referring now to FIG. 18, a flow diagram that depicts an embodiment of a method for correlating a variable with a likelihood to purchase a ticket is shown and described. The method may include providing a database of values for a plurality of variables (step 1801). Exemplary variables may include purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, or household composition. Other exemplary variables may be used. In some implementations, values for the variables are obtained through any sources of data described herein. In some implementations, the prospect evaluation platform 105 stores the data to provide the database of values.

The method may include correlating a variable with a likelihood to purchase a ticket to a sporting event based on the values in the database (step 1803). The processor may retrieve values for the variables from the database and determine a correlation between a variable and a likelihood to purchase a ticket. The correlation may be determined in any manner. In some implementations, a processor in a computing device may perform a statistical analysis on collected data regarding the variable from users to determine that the variable is correlated with the likelihood to purchase a ticket. In some implementations, the processor may perform linear and/or non-linear analysis on the collected data to determine the correlation. In some implementations, the processor may perform regression to determine the correlation. In some implementations, the processor may use any of the variables correlated with the likelihood to purchase a ticket in determining a pattern of data that may be correlated to engaging in a behavior of interest, as described herein.

Referring now to FIG. 19, a flow diagram that depicts an embodiment of a method for determining a priority rating, corresponding to a likelihood of purchasing a ticket to a sporting event, associated with a set of values for a set of variables. The method may include providing values for a plurality of variables corresponding to customer characteristics (step 1901). The values may be obtained via any of the sources of data described herein.

The method may include identifying from the plurality of variables a set of variables relating to an interest in sporting activity (step 1903). Exemplary variables for the set of variables may include purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, and/or household composition. In some implementations, the set of variables may be identified according to patterns of data correlated with a behavior of interest, as described herein. In some implementations, the set of variables may be identified according to patterns of data correlated with a likelihood to purchase one or more tickets to sporting events, as described herein.

The method may include selecting a value for each variable in the set of variables (step 1905). In some implementations, the processor selects the values according to data for individuals. The data for individuals may be obtained from the values for the plurality of variables corresponding to customer characteristics.

The method may include determining a priority rating for the selected values, the priority rating corresponding to a likelihood of purchasing a ticket to a sporting event (step 1907). In some implementations, the processor may obtain data on all individuals whose customer characteristics match the selected values for the set of variables. Based on past behavior of these individuals, the processor may determine a likelihood of purchasing a ticket to a sporting event. For example, the processor may retrieve data on fifteen males between the ages of 20-29, with incomes of $40,000-90,000. If nine of the fifteen males purchased a ticket to a sporting event in the past season, the processor may determine that the likelihood that individuals who are male, between the ages of 20-29, and have incomes between $40,000-90,000 have a 60% likelihood of purchasing a ticket to a sporting event. In some implementations, the 60% likelihood may corresponding to a 3 star priority rating. Thus, a 3 star priority rating may be determined for the 20-29 year old men with incomes of $40,000-90,000.

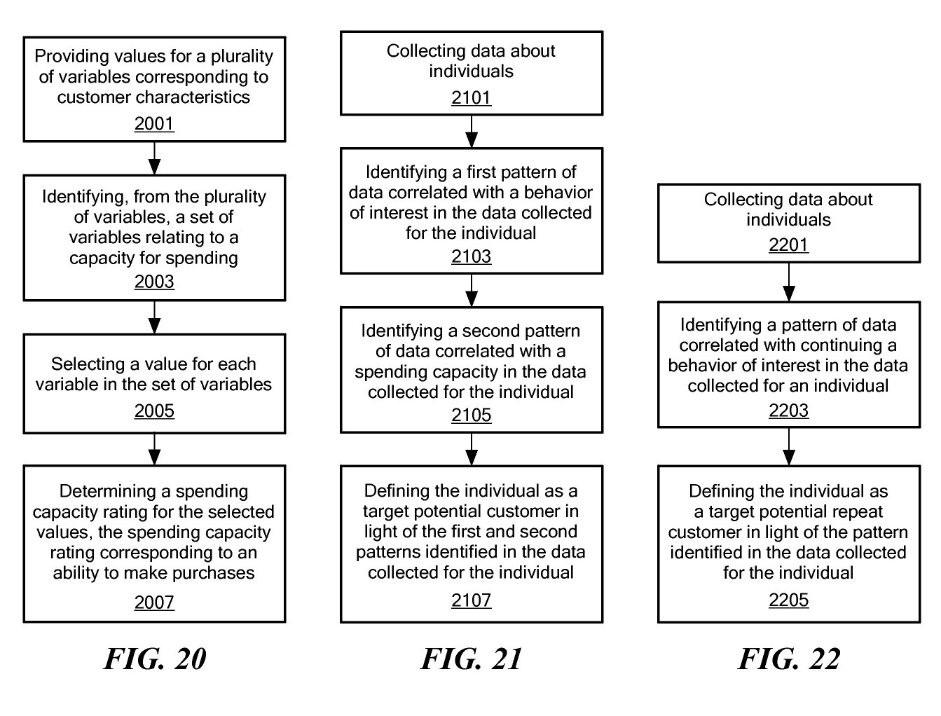

Referring now to FIG. 20, a flow diagram that depicts an embodiment of a method for determining a spending capacity rating, corresponding to an ability to make purchases, associated with a set of values for a set of variables. The method may include providing values for a plurality of variables corresponding to customer characteristics (step 2001). The values may be obtained via any of the sources of data described herein.

The method may include identifying from the plurality of variables a set of variables relating to a capacity for spending (step 2003). Exemplary variables for the set of variables may include age, gender, area of residence, distance from residence to a location hosting a sporting event associated with a sporting organization, length of residency, household income, homeownership status, type of property owned, value of property owned, number of children, age of the children, and/or level of education. In some implementations, the set of variables may be identified according to patterns of data correlated with spending capacity.

The method may include selecting a value for each variable in the set of variables (step 2005). In some implementations, the processor selects the values according to data for individuals. The data for individuals may be obtained from the values for the plurality of variables corresponding to customer characteristics.

The method may include determining a spending capacity rating for the selected values, the spending capacity rating corresponding to an ability to make purchases (step 2007). In some implementations, the processor may obtain data on all individuals whose customer characteristics match the selected values for the set of variables. The processor may determine spending capacity of individuals who exhibit the selected values for the set of variables. For example, the processor may retrieve data on twenty-five males between the ages of 30-45, with incomes of $90,000-125,000. The processor may determine that the males in this demographic have at least $25,000 of post-tax discretionary income. In some implementations, post-tax discretionary income between $20,000-30,000 may be associated with a spending capacity rating of 4 stars. Thus, a 4 star priority rating may be determined for the 30-45 year old men with incomes of $90,000-125,000.

Referring now to FIG. 21, a flow diagram that depicts an embodiment of a method for defining an individual as a target potential customer is shown and described. The method may include collecting data about individuals (step 2101). Data may be collected according to any of the methods described herein. Exemplary data to collect regarding individuals may include purchase of a ticket to a sporting event, frequency of purchase of tickets to sporting events, purchase of memorabilia related to a sporting organization, frequency of purchase of memorabilia related to the sporting organization, purchase of a ticket to a live entertainment event, frequency of purchase of tickets to live entertainment events, membership in a fan club for the sporting organization, subscription to a sports-related publication, web browser history related to interest in the sporting organization, a historical amount spent on goods related to the sporting organization, self-reported interest in the sporting organization, a response to communication from the sporting organization, household income, and/or household composition. Exemplary data may include age, gender, area of residence, distance from residence to a location hosting sporting events associated with the sporting organization, length of residency, household income, homeownership status, type of property owned, value of property owned, number of children, age of the children, and/or level of education. Patterns of data correlated with a behavior of interest and/or a spending capacity may be determined according to any of the methods described herein.

The method may include identifying a first pattern of data correlated with a behavior of interest in the data collected for an individual (step 2103). Exemplary behavior of interest may include purchase of a ticket to a sporting event, purchase of a premium-level ticket to a sporting event, purchase of a package of tickets for the sporting organization, purchase of a ticket subscription for the sporting organization, purchase of a ticket to an event associated with the sporting organization, and combinations thereof. The first pattern of data may be identified in the data collected for an individual according to any of the methods described herein.

The method may include identifying a second pattern of data correlated with a spending capacity in the data collected for the individual (step 2105). The second pattern of data may be identified in the data collected for the individual according to any of the methods described herein.

The method may include defining the individual as a target potential customer in light of the first and second patterns identified in the data collected for the individual (step 2107). In some implementations, the individual may be defined as a target potential customer when a pattern correlated with a behavior of interest and a pattern correlated with a spending capacity are both identified in the individual's data. For example, the individual may be a target potential customer when the individual's data matches a pattern associated with a 5-star rating regarding potential purchase of a season ticket and 3-star rating regarding spending capacity. The individual may be a target potential customer when the individual's data matches a pattern associated with a score over 80 out of 100 regarding potential purchase of a ticket to a sports team's fantasy vacation and a 5-star rating regarding spending capacity.

Referring now to FIG. 22, a flow diagram that depicts an embodiment of a method for generating a retention score for an individual and/or household is shown and described. Thus, the method may aid an organization in identifying individuals and/or households likely to be repeat customers for season tickets, ticket packages for multiple sporting events, and the like. The method may include collecting data about individuals (step 2201). The data may include at least data relating to purchase of a ticket to a sporting event, frequency of purchase of a ticket to a sporting event, purchase of memorabilia related to a sporting organization, frequency of purchase of memorabilia related to a sporting organization, purchase of a ticket to a live entertainment event, frequency of purchase of a ticket to a live entertainment event, membership in a fan club for a sporting organization, subscription to a sports-related publication, web browser history related to interest in a sporting organization, historical amounts spent on goods related to a sporting organization, self-reported interest in a sporting organization, responses to communication from a sporting organization, household income, or household composition. Any other data about an individual and/or household may be collected, including any of the data described herein.

The processor may determine a correlation between a pattern of data in the data collected for the individuals and continuation of a behavior of interest. Exemplary behaviors of interest may include purchasing a ticket to an event, purchasing a premium-level ticket to an event, purchasing a package of tickets, and/or purchasing a ticket subscription for an organization. Exemplary behaviors of interest may include purchasing a ticket to a football game, purchasing a ticket in a loge box for a baseball game, and/or purchasing a package of tickets to four basketball games. An exemplary behavior of interest may include purchasing a season ticket associated with a football team. Other behaviors of interest relating to an organization may be used, in any combination thereof.

A correlation between a pattern of data in the data collected for the individuals and continuation of a behavior of interest may be determined in any manner. In some implementations, a processor in a computing device may perform a statistical analysis on the collected data from the users to determine that a pattern of data is correlated with continuation of a behavior of interest. In some implementations, the processor may perform linear and/or non-linear analysis on the collected data to determine the correlation. In some implementations, the processor may perform regression to determine the correlation. In some implementations, the processor may determine that the pattern of data is correlated with continuation of a behavior of interest when a threshold percentage of individuals whose data matches the pattern have continued engaging in the behavior of interest.

In some implementations, if 60% of individuals whose data matches a first pattern purchased season tickets for a football team for more than one season, the processor may determine that the first pattern is correlated with the behavior of continuing to purchase season tickets. If 80% of individuals whose data matches a second pattern purchase season tickets for a football team for more than one season, the processor may determine that the second pattern is correlated with the behavior of continuing to purchase season tickets. In some implementations, if 50% of individuals whose data matches a third pattern purchase multiple packages with tickets to four baseball games, the processor may determine that the third pattern is correlated with the behavior of continuing to purchase multi-game packages of tickets. In some implementations, if 70% of individuals whose data matches a fourth pattern purchase multiple packages with tickets to four baseball games, the processor may determine that the fourth pattern is correlated with the behavior of continuing to purchase multi-game packages of tickets. Likewise, the processor may determine a correlation between any pattern of data collected for the individuals and any continued behavior of interest.

In some implementations, the pattern of data may be associated with the percentage of individuals whose data matches the pattern that continue to engage in the behavior of interest. In some implementations, the pattern of data may be associated with a retention score (e.g., 88 out of 100, 63 out of 100), a retention rating (e.g., 5 stars, 4 stars), or any other metric for conveying the desirability of the individual as a potential repeat customer.

The method may include identifying a pattern of data correlated with continuing a behavior of interest in the data collected for an individual (step 2203). In some implementations, the pattern of data may be modeled as a tree. The tree may account for possible values of the data. As the data collected for an individual is evaluated against the tree, the values may determine which nodes in the tree are to be traversed. In some implementations, evaluating the data against the tree may demonstrate that the individual's data matches the pattern represented by the tree.

The method may include defining the individual as a target potential repeat customer in light of the pattern identified in the data collected for the individual (step 2205). The individual may be identified as a target potential repeat customer when his or her data matches the pattern. The individual may be classified according to the retention score, retention rating, or other metric associated with the pattern. For example, if the data collected for an individual matches a pattern of data associated with a retention rating of 5 stars, the individual may be deemed a 5 star potential repeat customer.

Although some of the implementations described herein may be described with respect to sporting events or sporting organizations, the implementations may be applied to other types of events and organizations.

In view of the structure, functions and apparatus of the systems and methods of the platform described herein, the present solution provides a dynamic, efficient and intelligent system for generating prospect scores, spending capacity scores, and retention scores. Having described certain embodiments of methods and systems for providing such a platform, it will now become apparent to one of skill in the art that other embodiments incorporating the concepts of the disclosure may be used. Therefore, the disclosure should not be limited to certain embodiments like the one described herein.

What is claimed is:

1. A method comprising:
collecting data about individuals, the data including data relating to at least one of:
purchase of a ticket to a sporting event,
frequency of purchase of tickets to sporting events,
purchase of memorabilia related to a sporting organization,
frequency of purchase of memorabilia related to the sporting organization,
purchase of a ticket to a live entertainment event,
frequency of purchase of tickets to live entertainment events,
membership in a fan club for the sporting organization,
subscription to a sports-related publication,
web browser history related to interest in the sporting organization,
a historical amount spent on goods related to the sporting organization,
self-reported interest in the sporting organization,
a response to communication from the sporting organization,
household income,
household composition,
age,
gender,
area of residence,
distance from residence to a location hosting sporting events associated with the sporting organization,
length of residency,
household income,
homeownership status,
type of property owned,
value of property owned,
number of children, and
level of education;
identifying, by a processor, a first pattern of data correlated with a behavior of interest in the data collected for an individual, the behavior of interest including at least one of:
purchase of a ticket to a sporting event,
purchase of a premium-level ticket to a sporting event,
purchase of a package of tickets for the sporting organization,
purchase of a ticket subscription for the sporting organization,
purchase of a ticket to an event associated with the sporting organization, and combinations thereof;
identifying, by the processor, a second pattern of data correlated with a spending capacity in the data collected for the individual; and
defining, by the processor, the individual as a target potential customer in light of the first and second patterns identified in the data collected for the individual.

2. The method of claim 1, wherein collecting data further comprises:
collecting a first set of data selected from data relating to:
purchase of a ticket to a sporting event,
frequency of purchase of tickets to sporting events,
purchase of memorabilia related to a sporting organization,
frequency of purchase of memorabilia related to the sporting organization,
purchase of a ticket to a live entertainment event,
frequency of purchase of tickets to live entertainment events,
membership in a fan club for the sporting organization,
subscription to a sports-related publication,
web browser history related to interest in the sporting organization,
a historical amount spent on goods related to the sporting organization,
self-reported interest in the sporting organization,
a response to communication from the sporting organization,
household income, and
household composition,
collecting a second set of data selected from data relating to:
age,
gender,
area of residence,
distance from residence to a location hosting sporting events associated with the sporting organization,
length of residency,
household income,
homeownership status,
type of property owned,
value of property owned,
number of children,
age of the children, and
level of education.

3. The method of claim 1, wherein the web browser history related to interest in the sporting organization comprises a number of viewings of a website for purchasing a ticket for sporting events.

4. The method of claim 1, wherein the self-reported interest in the sporting organization comprises interest reported in a questionnaire, a survey, or both.

5. The method of claim 1, wherein the location hosting a sporting event associated with the sporting organization comprises a sporting arena or a sporting stadium.

6. The method of claim 1, wherein the purchase of a ticket subscription for the sporting organization comprises purchase of tickets for a full season.

7. The method of claim 1, wherein the purchase of a ticket subscription for the sporting organization comprises purchase of tickets for a partial season.

8. The method of claim 1, wherein the purchase of a ticket to an event associated with the sporting organization comprises purchase of a ticket to a live entertainment event hosted in conjunction with the sporting organization.

9. The method of claim 1, wherein the purchase of a ticket to an event associated with the sporting organization comprises purchase of a ticket to an event tailored to existing supporters of the sporting organization.

10. The method of claim 1, wherein the purchase of a ticket to an event associated with the sporting organization comprises purchase of a ticket to meet or travel with members of the sporting organization.

11. A method comprising:
collecting data about individuals, the data including at least data relating to:
purchase of a ticket to a sporting event,
frequency of purchase of a ticket to a sporting event,
purchase of memorabilia related to a sporting organization,
frequency of purchase of memorabilia related to a sporting organization,
purchase of a ticket to a live entertainment event,
frequency of purchase of a ticket to a live entertainment event,
membership in a fan club for a sporting organization,
subscription to a sports-related publication,
web browser history related to interest in a sporting organization,
historical amounts spent on goods related to a sporting organization,
self-reported interest in a sporting organization,
responses to communication from a sporting organization,
household income, or
household composition;
identifying, by a processor, a pattern of data correlated with a behavior of interest in the data collected for an individual, the behavior of interest including at least one of:
purchase of a ticket to a sporting event,
purchase of a package of tickets for a sporting organization,
purchase of a ticket subscription for the sporting organization, or
combinations thereof;
defining, by the processor, the individual as a target potential customer in light of the pattern identified in the data collected for the individual.

12. A method comprising:
providing a database of values for a plurality of variables, the plurality of variables including at least one of:
purchase of a ticket to a sporting event,
frequency of purchase of a ticket to a sporting event,
purchase of memorabilia related to a sporting organization,
frequency of purchase of memorabilia related to a sporting organization,
purchase of a ticket to a live entertainment event,
frequency of purchase of a ticket to a live entertainment event,
membership in a fan club for a sporting organization,
subscription to a sports-related publication,
web browser history related to interest in a sporting organization,
historical amounts spent on goods related to a sporting organization,
self-reported interest in a sporting organization,
responses to communication from a sporting organization,
household income, or
household composition;
correlating, by a processor, a variable with a likelihood to purchase a ticket to a sporting event based on the values in the database.

13. A method comprising:
providing values for a plurality of variables corresponding to customer characteristics;
identifying, by a processor, from the plurality of variables, a set of variables relating to an interest in sporting activity, the set of variables including at least one of:
purchase of a ticket to a sporting event,
frequency of purchase of a ticket to a sporting event,
purchase of memorabilia related to a sporting organization,
frequency of purchase of memorabilia related to a sporting organization,
purchase of a ticket to a live entertainment event,
frequency of purchase of a ticket to a live entertainment event,
membership in a fan club for a sporting organization,
subscription to a sports-related publication,
web browser history related to interest in a sporting organization,
historical amounts spent on goods related to a sporting organization,
self-reported interest in a sporting organization,
responses to communication from a sporting organization,
household income, or
household composition;
selecting, by the processor, a value for each variable in the set of variables; and
determining, by the processor, a priority rating for the selected values, the priority rating corresponding to a likelihood of purchasing a ticket to a sporting event.

14. A method comprising:
providing values for a plurality of variables corresponding to customer characteristics;
identifying, by a processor, from the plurality of variables, a set of variables relating to a capacity for spending, the set of variables including at least one of:
age,
gender,
area of residence,
distance from residence to a location hosting a sporting event associated with a sporting organization,
length of residency,
household income,
homeownership status,
type of property owned,
value of property owned,
number of children,
age of the children, or
level of education;
selecting, by the processor, a value for each variable in the set of variables; and
determining, by the processor, a spending capacity rating for the selected values, the spending capacity rating corresponding to an ability to make purchases.

15. A method comprising:
collecting data about individuals, the data including at least data relating to:
purchase of a ticket to a sporting event,
frequency of purchase of a ticket to a sporting event,
purchase of memorabilia related to a sporting organization,
frequency of purchase of memorabilia related to a sporting organization,
purchase of a ticket to a live entertainment event,
frequency of purchase of a ticket to a live entertainment event,
membership in a fan club for a sporting organization,
subscription to a sports-related publication,
web browser history related to interest in a sporting organization,
historical amounts spent on goods related to a sporting organization,
self-reported interest in a sporting organization,
responses to communication from a sporting organization,
household income, or
household composition;
identifying, by a processor, a pattern of data correlated with continuing a behavior of interest in the data collected for an individual, the behavior of interest including at least one of:
purchase of a ticket to a sporting event,
purchase of a package of tickets for a sporting organization,
purchase of a ticket subscription for the sporting organization, or
combinations thereof;
defining, by the processor, the individual as a target potential repeat customer in light of the pattern identified in the data collected for the individual.
